(19) United States
(12) Patent Application Publication
(10) Pub. No.: US 2009/0044687 A1
(43) Pub. Date: Feb. 19, 2009

(54) System for integrating music with an exercise regimen

(76) Inventor: Kevin Sorber, Exeter, NH (US)

Correspondence Address: Russ Weinzimmer, 614 Nashua St. #204, Milford, NH, 03055, US

(21) Appl. No.: 11/893,053

(22) Filed: Aug. 13, 2007

(51) Int. Cl. G10H 7/00

(52) U.S. Cl. 84/609

(57) ABSTRACT

A system is disclosed for selecting and integrating music received from a user's personal music library into an exercise routine. The system includes a music analyzer software module that characterizes rhythmic qualities of each song in the music library, creating a rhythmically quantified collection of the user's music which serves as one input to a song selection module. Other inputs to the selection module include target workout parameters and user defined data that include the user's physical metrics and the user's preferences for song selection and repetition. Real time data associated with the user's physical activity can also be supplied to the selection module, which associates particular songs with the user's physical activity. The song selection module supplies the selected songs in a sequential fashion to a personal music device worn by the user while the user is engaged in a structured type of physical exertion.

### FIELD OF THE INVENTION

The present invention relates generally to the field of data processing, and more particularly to the processing of audio data in response to the real or desired physical activity of a person engaged in a repetitive exercise.

### BACKGROUND OF THE INVENTION

Persons engaging in a repetitive physical activity frequently find that a musical accompaniment is helpful in maintaining a desired exertion level. Centuries ago teams of laborers performing work such as planting or digging found that singing or chanting was helpful in maintaining a desired rate of activity. In our modern age portable electronic devices such as radios, compact disc players and stored digital audio file players permit an individual to listen to music in many different settings including both during work and recreational activities. In particular, the development of compact computer memory permits an individual to create a catalog of hundreds of user selected songs that can be played in any desired order by means of a pocket sized audio reproduction device. While such devices can be used while performing physical labor, a more common use of body worn audio players is while exercising either at home or in a gymnasium. During such an exercise session, the user typically performs specific exercises during a specific time period. In many cases the user has access to various physiological and performance monitors that inform the user in real time of parameters such as pulse rate, blood pressure, dissolved oxygen, stride length, velocity, distance traveled or distance remaining.

Past attempts have been made to integrate music with a physical activity. For example, U.S. Pat. No. 4,674,743 entitled “ATHLETIC TRAINING UNIT WITH MUSICAL RHYTHM REPRODUCING SPEAKER AND EXERCISER'S PULSE DETECTING MEANS”, issued to Hirano on Jun. 23, 1987, discloses a baton like radio receiver that detects a transmitted music signal which is also applied to a low-pass filter in order to derive an undertone component or beat. The undertone component is amplified and then applied to a vibrating component of a speaker. The beats representing the rhythm of the music are reproduced by the vibrating component as mechanical vibrations which are sensed by the user and which assist the user in setting their exertion level to a rate matching the beat of the transmitted music. In the Hirano device the music is selected by a trainer or instructor and transmitted to the user at times selected by the instructor.

A more automated exercise rate regulation system is disclosed in U.S. Pat. No. 6,527,674, entitled “INTERACTIVE PROGRAMMABLE FITNESS INTERFACE SYSTEM”, issued to Clem on Mar. 4, 2003. In the Clem device, a variety of preprogrammed exercise routines are selected automatically in response to past performance of the user and physiological parameters measured while the user is exercising. Music accompanies the preprogrammed exercise routines. The Clem disclosure states that the “speed” of the music may be adjusted by the program to affect the user's workout, “either consciously or subconsciously”.

Neither the Hirano nor the Clem device permits a person who is engaged in an exercise activity to utilize music that the user has selected from their own personal library of audio files. Further, no means is suggested to enable a user to select music from their personal audio library that would be appropriate for any particular type or rate of exercise activity. What is needed is a system which provides an automated analysis of the rhythm or beat of the music residing in the user's own audio library and then provides some means of integrating selections from that audio library into the user's exercise regimen at an appropriate time and for an appropriate duration.

### SUMMARY OF THE INVENTION

The system of the present invention enables a person engaged in an exercise routine or other physical activity to access music from their personal collection of audio files. The music is selected by a song selection module according to an algorithm that identifies music that is appropriate for use while exercising during a specific workout routine or portion thereof. In one embodiment of the invention the user enters a series of parameters, such as workout profiles, target workout goals and the length of the exercise activity. In response to the user entered parameters, a song selection module searches and analyzes the songs present in the user's audio files and generates a series of playlists tailored to specific potential exercise routines. One or more of the generated playlists can then be conveniently uploaded to the user's personal music device, with the playlist being initiated at the start of the workout routine. In a second embodiment of the present invention the song selection module is provided with additional inputs that provide access to real time physiological or other monitors that indicate the user's physical state. The song selection module compares the actual activity of the user with the list of available songs and then selects songs or portions thereof that have an appropriate beat, tempo or rhythm for the input data being received.

### BRIEF DESCRIPTION OF THE DRAWINGS

FIG. 1 is a block diagram of a music integration system constructed according to the principles of the present invention;

FIG. 2 is a block diagram depicting the function of the music analyzer illustrated in FIG. 1;

FIG. 3 is a block diagram depicting the user input data used to create the user options library illustrated in FIG. 1;

FIG. 4 is a block diagram depicting the creation of the workout profiles library illustrated in FIG. 1;

FIG. 5 is a block diagram depicting the creation of the target workout parameters illustrated in FIG. 1;

FIG. 6 is a block diagram depicting the creation of the real time workout data illustrated in FIG. 1;

FIG. 7 is a flow chart depicting the creation of the target beats per minute value by the song selection module illustrated in FIG. 1; and

FIG. 8 is a flow chart depicting the data processing steps used by the song selection module illustrated in FIG. 1 to select a song from a user's library of audio files.

### DETAILED DESCRIPTION OF THE INVENTION

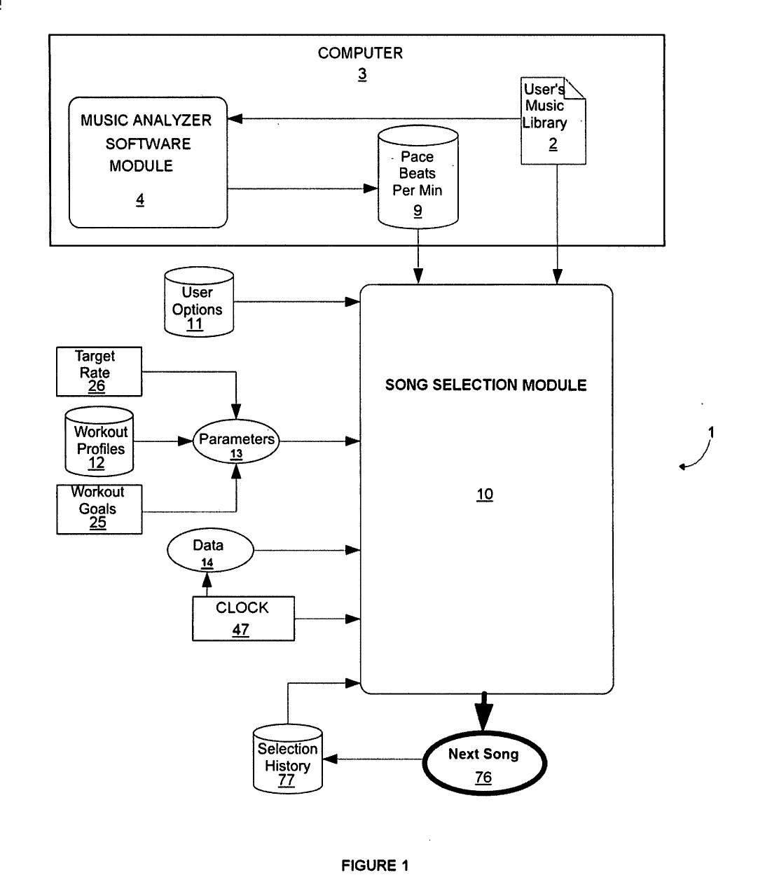

Referring to FIG. 1, the system 1 of the present invention includes access to the user's music library 2. The library 2 is typically a collection of digital music files stored in various standardized formats, the library typically residing on the user's computer 3 or being accessible to the user via a network. The library 2 may be subdivided into various folders corresponding to user defined playlists. The user may at any time add or delete audio file locations that will be available for use by the system 1.

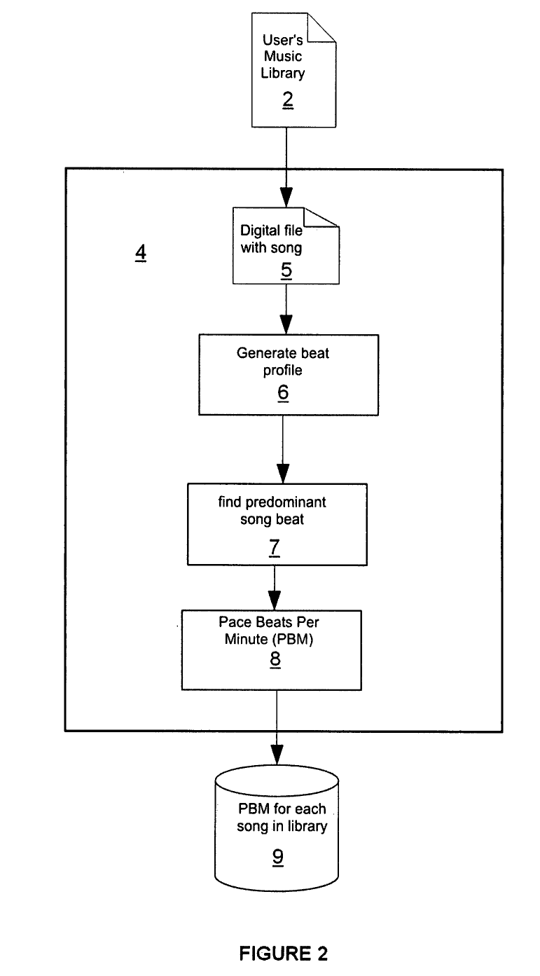

Included in the system 1 is a music analyzer software module 4. Referring to FIG. 2, the function of the module 4 may be better understood. Music residing within the user's library 2 is forwarded to the module 4, each song appearing as a digital music file 5. The primary purpose of the module 4 is to determine and characterize the beat or tempo of each song within the music library 2. As a first step 6 in performing the beat analysis, a beat profile is generated using one of several methods. For example, a third party utility program may be used or the raw data in each music file may be analyzed, such as is described in U.S. Pat. No. 7,031,980, entitled “MUSIC SIMILARITY FUNCTION BASED ON SIGNAL ANALYSIS”, issued to Logan et al. on Apr. 18, 2006. Alternatively, the music contained in each file may be played through a music analyzer and characterized by the analyzer output. Regardless of the method used, step 6 generates the beat or rhythm of each song at a given point in time of the song.

The beat profile generated at step 6 is further processed at step 7 in which the many individual beat values generated at step 6 are statistically analyzed for the entire song. By removing any beat anomalies such as the introduction, transition and ending portions of the song, a single pace beat per minute (PBM) value 8 is assigned to the song. The PBM value represents the pace which a runner or walker would achieve if they were to synchronize their exertion level with the predominant beat of the music. The analyzer module 4 examines and characterizes each song in the music library 2 and forwards the results of the analysis to the music library PBM value depository 9.

The contents of the PBM value depository 9 as well as the files in the user's music library 2 are forwarded to the song selection module 10. The purpose of the module 10 is to choose a particular song from the library 2 that is appropriate to accompany an exercise routine or other physical activity. Each song that becomes a selected song 76 is stored in library 77 of selected songs that is available to monitor how frequently each song is played. The selection of a song is also dependent on various user defined parameters including user options 11 and the target workout parameters 13. The target workout parameters 13 are based on several factors including the workout profiles 12, the target workout goal 25 and the target workout rate 26 needed to achieve the workout goal 25.

When the system 1 is operating in a real time mode, the song selection module 10 will also incorporate real time data 14 which can include, for example, the pace, heartbeat or physical location of the user. When the system 1 is operating in a play list mode real data 14 is not needed, and the song selection module 10 is accessed in an iterative manner in order to generate a list of songs based on the user options 11, the workout profiles 12 and the target workout parameters 13.

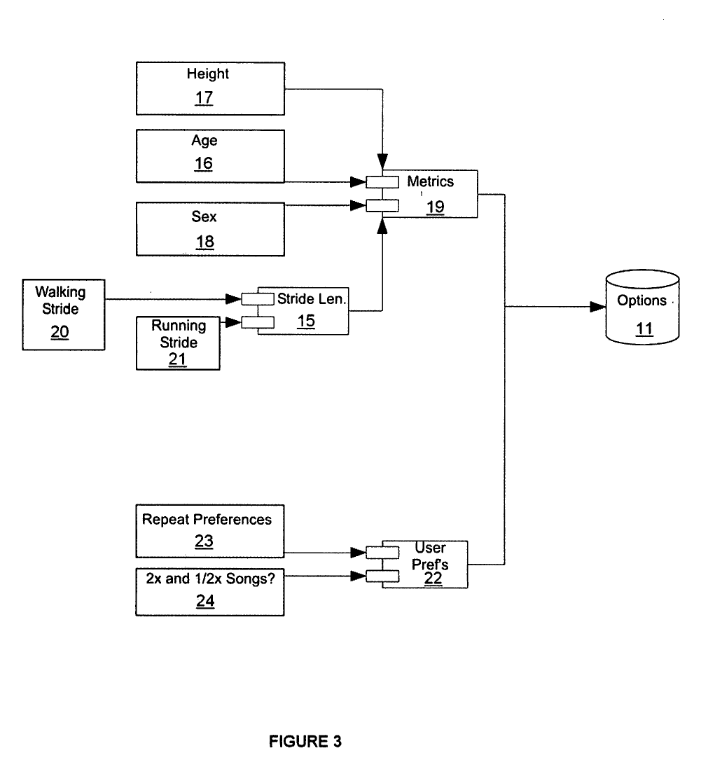

Referring also to FIG. 3, the creation of the user options 11 can be appreciated. Initially the user's age 16, the user's height 17 and the user's sex 18 are entered to create the user's physical metrics 19. Another parameter that is unique to an individual user is their stride length 15, which is the distance a person advances as the result of taking one average step during a paced walk or run. The walking stride length 20 and the running stride length 21 may be measured and subsequently entered by the user or the values 20 and 21 may be estimated based on the physical metrics 19.

User preferences 22 are those related to the presentation of a song once that song has been selected by module 10. The user repeat preference 23 is a number indicating how often the same song can be repeated within a single given workout session. A lower number denotes that a song can be replayed more frequently to the extent that a particular song aids in achieving the desired target workout pace. A higher number denotes that a variety of music should be played even if the variety results in some divergence from the desired target pace. To allow for a greater variety in music selection the “Allow 2x and ½x Time Songs” may be specified at step 24. By selecting songs that have twice (2x) the desired beat and half (½x) the desired beat, songs will be eligible for selection by the music selection module 10 if the PBM value 8 is 50% or 200% of the desired target pace beats per minute value for a particular exercise routine. A ½x (or 50% of PBM) song selection would represent the user taking 2 strides for every beat of music, and a 2x (or 200% of PBM) song selection would represent the user taking 1 step for every 2 music beats.

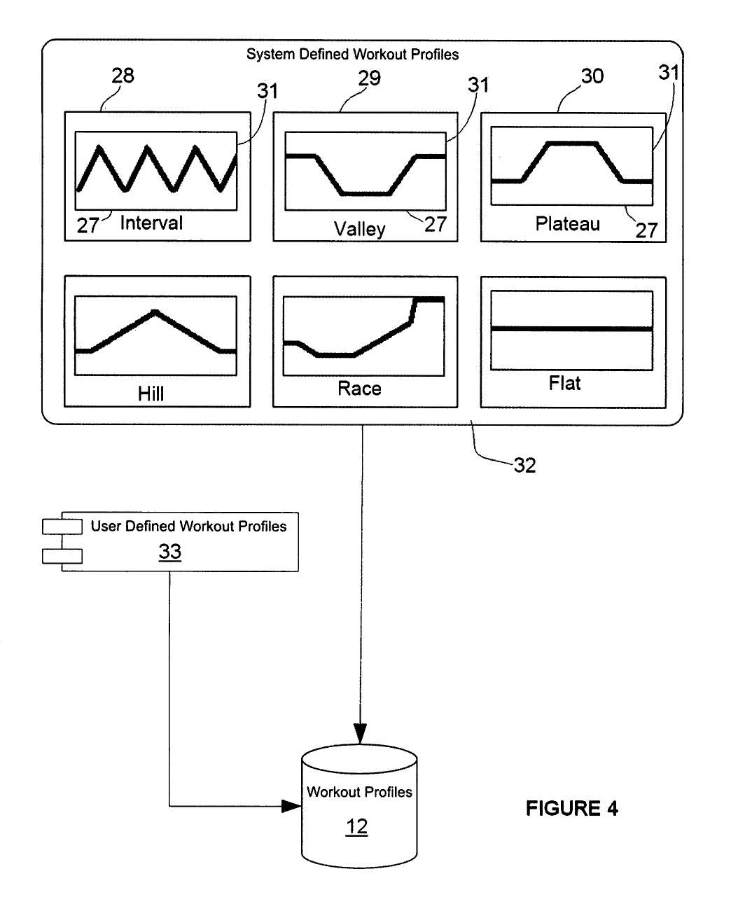

Referring also to FIG. 4, the nature of the stored workout profiles 12 can be better appreciated. Each workout profile 12 defines the pace target within a workout or exercise routine. The x-axis 27 of each workout chart 28, 29 and 30, for example, defines the total time elapsed or distance traveled for a particular workout, on a scale of one to one hundred percent. The y-axis 31 of each workout chart denotes the pace of the workout in units of distance/minute or heart rate beats per minute. The charts 28, 29 and 30 are all part of a group of system defined workout profiles 32 and may be adopted without change by the user or they may serve as templates for user defined workout profiles 33. A user may copy a system designed workout profiles 32 as the basis for a user defined workout profile, or design an entirely new profile in order to create user defined workout profile 33.

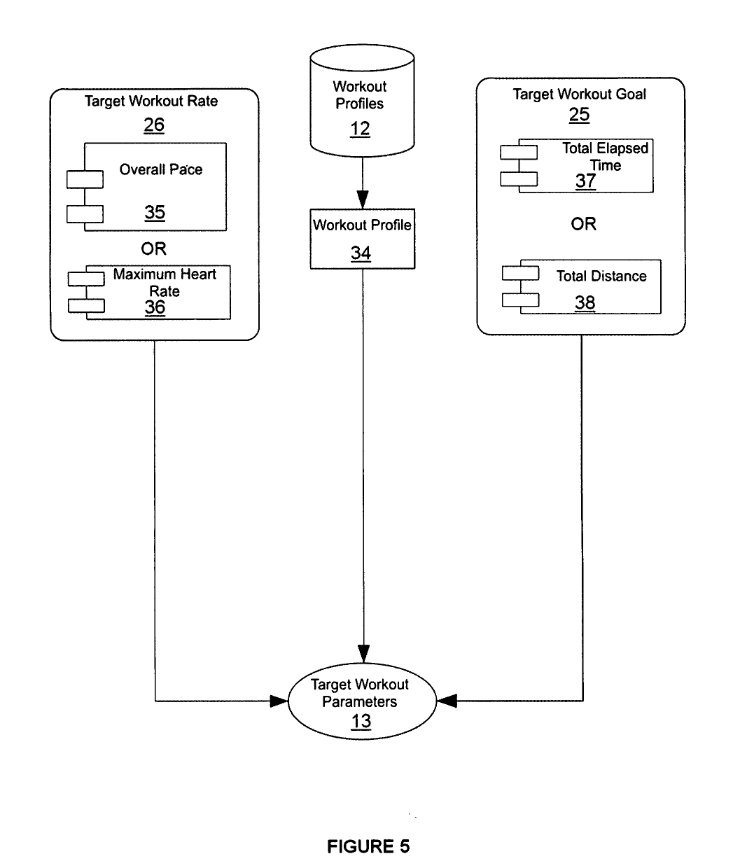

The workout profiles 12 are one input component of the target workout parameters 13, as seen in FIG. 5. From the collection of saved workout profiles 12 a single workout profile 34 is selected for use at any one time during a given exercise session. The user further selects the target workout rate 26 which is expressed as an overall pace 35 that is either a distance traveled per unit of time or as a maximum pulse rate 36, the latter being expressed in units of heartbeats per minute. The user also selects the target workout goal 25 which may be expressed either as a total workout elapsed time 37 or as a total distance traveled 38.

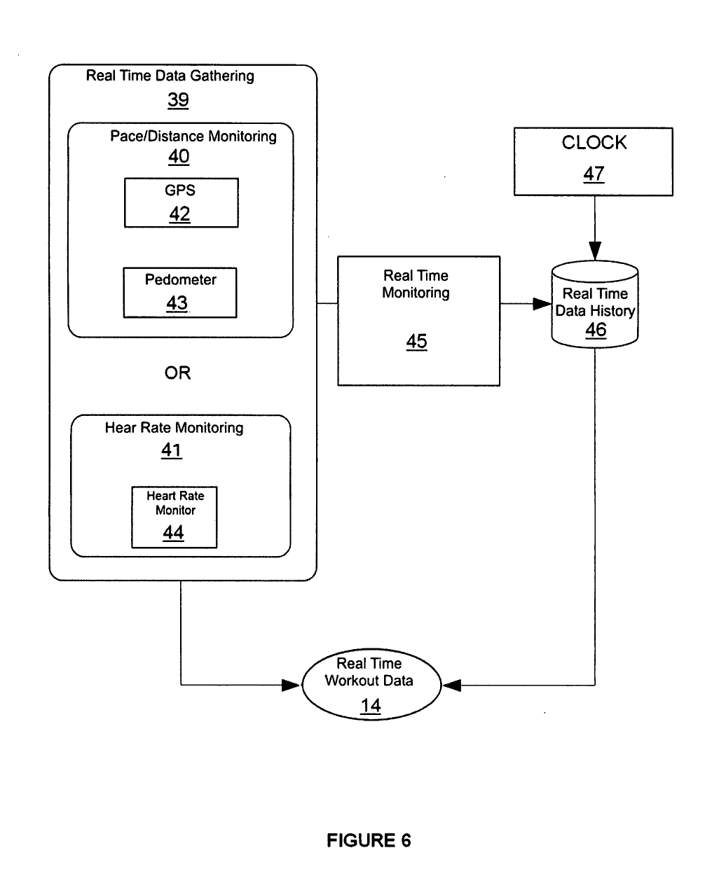

In order to adjust the selections made by the song selection module 10 in response to the activity of the user during an exercise routine, real time workout data 14 is supplied to the module 10 as shown in FIG. 1. Referring also to FIG. 6, the real time data gathering module 39, which serves as a source of real time workout data 14, contains both a pace/distance monitoring component 40 and a heart rate monitoring component 41. In the preferred embodiment of FIG. 6, the pace/distance monitoring component includes a global positioning system receiver 42 and a pedometer 43. In other preferred embodiments, in lieu of the heart rate monitoring component 41, the real time data gathering module 39 contains a physiological monitoring unit that includes a heart rate monitor 44 and additional biosensors such as a respiration rate and/or a dissolved blood oxygen monitor. Regardless of the type of information being monitored, the real time data gathering module produces real time data 45 which is forwarded to a data sample repository 46. When synchronized with the clock 47, the workout data such as the total distance traveled and the overall pace for the entire workout up to the present time may be calculated and utilized by the song selection module 10.

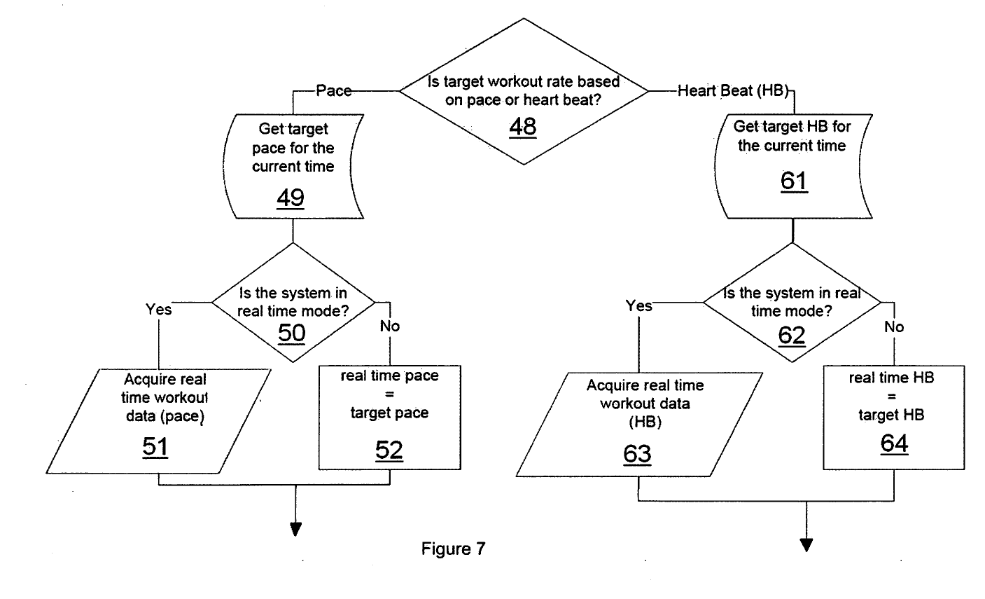

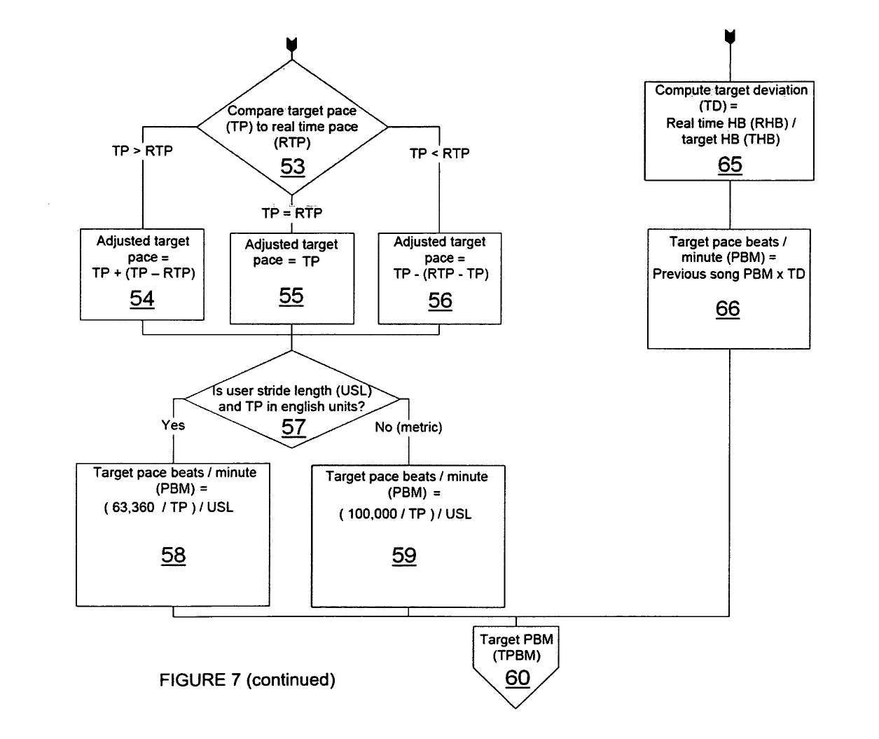

Given the foregoing discussion of the various inputs to the song selection module 10, the song selection protocol utilized by module 10 will now be discussed with particular reference to FIG. 7. Initially, a decision is made at step 48 as to the basis of defining the target workout rate 26. If the user has selected a pace based target workout rate, then the overall target pace 35 for the current time is retrieved at step 49. The determination is then made at step 50 as to whether or not real time data is available to the system 1. Assuming the presence of real time data, processing step 51 acquires the real time data 14 as provided by the real time data gathering module 39. If real time data is not available, then processing step 52 defines the real time pace as being equal to the target pace.

The logical IF statement 53 then determines if the target pace (TP) of the workout routine is greater than, equal to or less than the real time pace (RTP) being achieved by the user. If the target pace is greater than the real time pace, then an adjusted target pace is defined at step 54 as being equal to TP+(TP−RTP). If the target pace is equal to the real time pace, such as is the case when real time data 14 is unavailable, then step 55 defines the adjusted target pace as being equal to the target pace. In those cases where the target pace is less than the real time pace, data processing step 56 defines the adjusted target pace as being equal to TP−(RTP−TP).

The next processing step 57 determines if the user stride length 15 (USL) is defined in english or metric units. If english units are used, then the english units calculation step 58 defines the target pace beats per minute (TPBM) as (63,360/TP)/USL, where the value of TP is given in minutes per mile and the value of USL is given in inches. When metric units are used to define the user stride length 15, metric units calculation step 59 defines the TPBM as (100,000/TP)/USL, where the value of TP is given in minutes per kilometer and the value of USL is given in centimeters. Regardless of the units originally chosen by the user, the value of the target beats per minute (TPBM) is ultimately defined at step 60.

Returning to the analysis performed at step 48 regarding the basis for defining the target workout rate 26, if the workout rate definition is based on the user's heartbeat, then the maximum target heartbeat 36 for the current time is retrieved at step 61. The determination is then made at step 62 as to whether or not real time data is available to the system 1. Assuming the presence of real time data, processing step 63 acquires the real time heart beat (RHB) data 14 as provided by the real time data gathering module 39. If real time data is not available, then processing step 64 defines the real time heart beat (RHB) as being equal to the target heart beat (THB). Target deviation (TD) between the real and target heart beats is then defined at step 65 as RHB/THB. Once the target deviation (TD) has been obtained, step 66 defines the target beats per minute (TBPM) value as being equal to the pace beats per minute 8 value that has already been calculated by the music analyzer software module 4 for the previous song played.

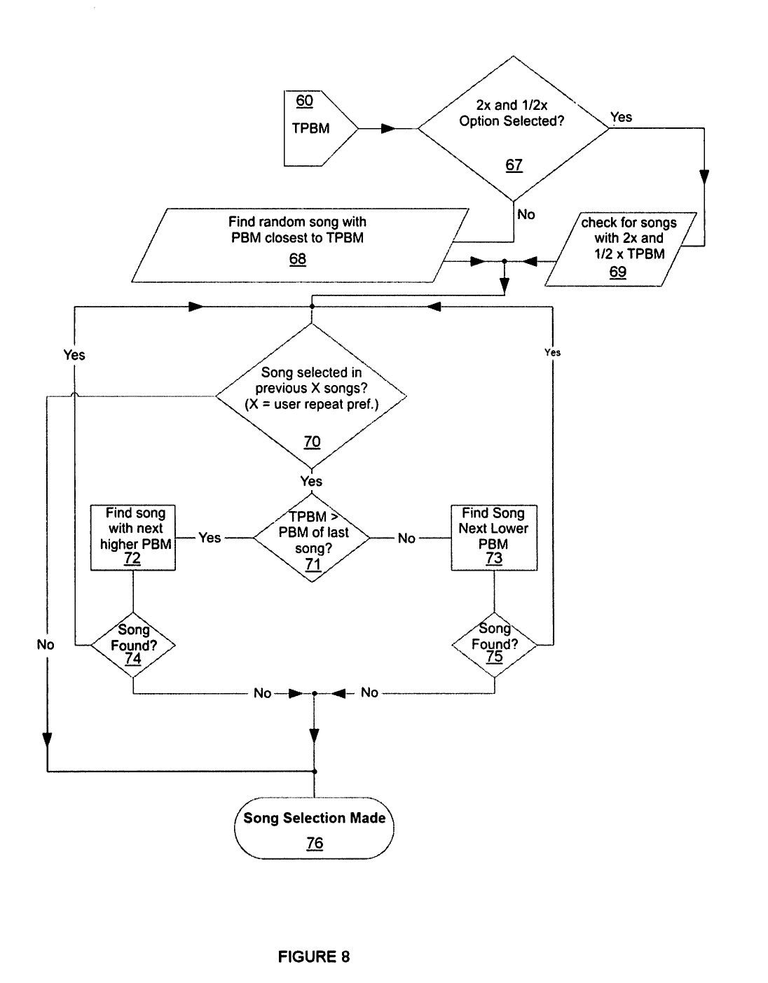

Referring also to FIG. 8, after the TPBM value has been obtained at step 66, the song selection module 10 determines at step 67 if the user has enabled at step 24 the selection of the entire range of songs having anywhere from half to twice the target beats per minute value. If the answer is yes, then step 69 permits the module 10 to select songs meeting that criterion. Otherwise, the selection module searches at step 68 only for the song having the PBM closest to the TPBM. The song tentatively selected at step 68 is then compared at step 70 to the song selection history 77 to determine if that particular song has been previously chosen within the last X songs, where X is the permissible frequency of song repetition as entered previously by the user at step 23. If the song has not been played within the last X song selections, then that particular song is the next song to be played for the user at step 76.

If the song tentatively selected at step 68 has been played within the last X song selections, then data processing step 71 determines if the TPBM is less than or greater than the PBM of the song previously selected at step 76. If the TPBM is greater than the PBM of the previous song, then step 72 directs the module 10 to select the song within the music library 9 that has the next highest PBM value. If no such song is found to exist at step 70, then the tentative song chosen at step 68 becomes the final song selection 76. On the other hand, if a new song is found to exist at step 74, then the new tentative song selection is forwarded to song history comparison step 70 to determine if the new song is eligible to be played.

If data processing step 71 determines that the song previously selected at step 76 has a TPBM that is less than the PBM of the previous song, then step 73 directs the module 10 to select the song within the music library 9 that has the next lowest PBM value. If no such song is found to exist at step 75, then the tentative song chosen at step 68 becomes the final song selection 76. If a new song is found to exist at step 75, then the new tentative song selection is forwarded to song history comparison step 70 to determine if the new song is eligible to be played. In this manner the song selection module 10 is biased toward choosing successive songs that have not been played excessively, as defined by the user, and which have a PBM value that is as near to the TPBM as possible.

While certain forms of the system 1 have been illustrated, the invention is not limited to the specific arrangement of the components and the specific function of the data processing steps as described and shown. Various changes may be made by those skilled in this field to the specific embodiments as described without departing from the scope of the invention. In particular, the song selection module 10 may employ many alternative and additional song selection schemes while still utilizing the concept of characterizing the pace beat per minute value or other tempo parameter of a song, or portion thereof, and comparing that value to the target pace beat per minute or other repetition rate derived value. Accordingly, the above description is not intended to limit the invention except as indicated in the following claims.

What is claimed is:

1. A system for managing a pace of physical exertion by a user, comprising:
a music library, the music library containing a plurality of musical entries;
a music analyzer, the music analyzer determining a characteristic of at least one musical entry in the music library according to at least one of:
(a) a recurrent beat appearing within the musical entry; and
(b) a rhythmic feature of the musical entry; and
a song selection module, the song selection module comparing a desired exertion pace with a characteristic of each song analyzed by the music analyzer, the song selection module choosing at least one song to be played to the user during physical exertion, the song having a characteristic that is similar to the desired exertion pace.

2. A system according to claim 1 wherein the music library is available to a user of the system via at least one of:
(a) a personal computer; and
(b) a computer network.

3. A system according to claim 1 wherein the music analyzer assigns to each musical entry in the music library a numerical value corresponding to the characteristic of the musical entry determined by the music analyzer.

4. A system according to claim 3 wherein the song selection module further comprises:
a first input, the first input being the numerical value assigned to each musical entry by the music analyzer;
a second input, the second input being each musical entry contained in the music library.

5. A system according to claim 4 wherein the song selection module includes a third input comprising physical exertion parameters, the song selection module being adapted to select a musical entry that is biased to assist a user in maintaining at least one of the physical exertion parameters.

6. A system according to claim 5 including
a personal audio reproduction device for establishing communication with the song selection module while the user is engaged in an act of physical exertion.

7. A system according to claim 5 wherein the physical exertion is a repetitive activity.

8. A system according to claim 7 including
a communication interface for establishing real time communication between the song selection module and at least one physical exertion monitor, the physical exertion monitor generating data regarding the level of physical exertion of the user while the user is performing the repetitive activity.

9. A system according to claim 8 further comprising a user preferences input to the song selection module, the user preferences input comprising at least one of:
(a) a number of times an individual musical entry may be chosen by the song selection module; and
(b) a measure of acceptable deviation between the numerical value assigned to the musical entry by the music analyzer and a repetitive characteristic of the physical exertion.

10. A system according to claim 5 wherein the physical exertion is characterized by at least one of:
(a) a heartbeat of the user; and
(b) a distance traveled by the user.

11. A system according to claim 3, wherein the numerical value assigned to each musical entry is defined as a pace beats per minute (PBM) value.

12. A system according to claim 5 further comprising a library of workout profiles, each workout profile defining a target pace within a workout routine.

13. A system according to claim 12, wherein each workout profile defines at least one of:
(a) a current distance traveled per minute value for a cumulative distance traveled by a user within a particular workout;
(b) a current heart rate value for a cumulative distance traveled by a user within a particular workout;
(c) a cumulative distance traveled for a current elapsed time within a particular workout; and
(d) a current heart rate value for a current elapsed time within a particular workout;

14. A system for integrating a song into a physical workout routine performed by a user, comprising:
a library of songs compiled by the user;
a library of workout routines selectable the user;
a music analyzer for detecting and quantifying a rhythmic characteristic of the songs within the library; and
a song selection module, the song selection module:
(a) comparing a rhythmic quality within at least a portion of each workout routine with the rhythmic characteristic of each song in the library of songs;
(b) selecting a song from the library of songs, the song having a rhythmic characteristic that is similar to the rhythmic quality of the workout routine chosen by the user; and
(c) communicating the song to a personal audio reproduction device accessible to the user, the song being played during the workout routine.

15. The system of claim 14, wherein the music analyzer further comprises:
a means for retrieving each music file representing a song from the library of songs;
a means for generating a beat profile of each song;
a means for analyzing the beat profile of each song to determine a predominant beat of each song;
generating a pace beats per minute (PBM) value for each song corresponding to the predominant beat of each song; and
storing each PBM value in a library of PBM values, the library of PBM values being accessible by the song selection module.

16. The system of claim 15, further including set of target workout parameters, the target workout parameters being derived from:
the library of workout routines;
a target workout goal, the target workout goal being one of:
(a) a total workout elapsed time;
(b) a total distance traveled by the user during the workout; and
a target workout rate, the target workout rate being one of:
(a) a distance traveled by the user per unit of time; and
(b) a maximum pulse rate of the user.

17. A system according to claim 16 further comprising a plurality of user inputs, the user inputs being accessible by the song selection module, the user inputs including at least one of:
(a) the user's height;
(b) the user's gender;
(c) the user's age;
(d) the user's walking stride length;
(e) the user's running stride length;
(f) a number of songs that must be played between a repetition of any song; and
(g) a maximum permissible deviation of the PBM value of a song from a target pace beats per minute (TPBM) value present in the song selection module.

18. A system according to claim 17 further comprising at least one sensor interfaced to the song selection module for supplying real time data to the song selection module regarding at least one measure of an exertion level of the user while performing the workout routine.

19. A method for selecting a song for playback to a user while the user is performing an exercise routine, the method comprising the steps of:
accessing a collection of user selected songs from a computer readable medium;
assigning a numerical value to each song based on a characterization of each song in the collection;
determining a desired rate at which the exercise routine should be performed in order to achieve a goal selected by the user;
associating the numerical value of each song with a repetitive characteristic of the exercise routine when the exercise routine is performed at the desired rate; and
selecting a song from the collection of user selected songs based on an association between the numerical value of the song and the repetitive characteristic of the exercise routine when performed at the desired rate.

20. The method for selecting a song according to claim 19, further comprising the activities of:
(a) monitoring a parameter indicative of an exertion rate of the user while performing the exercise routine, and;
(b) associating the numerical value of each song with a repetitive characteristic of the exertion rate of the user while the user is performing the exercise routine; and
(c) selecting a song from the collection of user selected songs based on an association between the numerical value of the song and the repetitive characteristic of the exertion rate of the user when performing the exercise routine.
